(19) United States
(12) Patent Application Publication
(10) Pub. No.: US 2016/0112941 A1
(43) Pub. Date: Apr. 21, 2016

(54) CONNECTION SELECTION IN HYBRID NETWORKS

(71) Applicant: Microsoft Corporation, Redmond, WA (US)

(72) Inventors: Anish Desai, Bellevue, WA (US); Gursharan S. Sidhu, Seattle, WA (US); Mansoor Jafry, Kirkland, WA (US); John Mark Miller, Kirkland, WA (US); Humayun Khan, Issaquah, WA (US); Ranveer Chandra, Bellevue, WA (US); Spencer Fowers, Bellevue, WA (US)

(21) Appl. No.: 14/519,474

(22) Filed: Oct. 21, 2014

(51) Int. Cl. H04W 48/18; H04M 7/00; H04W 24/08

(52) U.S. Cl. CPC H04W 48/18; H04W 24/08; H04M 7/006

(57) ABSTRACT

A methodology for automatic selection of a connection, on behalf of a device user, to a hybrid network for calls is provided in which a combination of a variety of inputs is utilized to populate a filtered list of available connections that is sorted by connection cost in which the least costly connection is at the top of the list. The methodology is executed periodically, or in response to event occurrence such as a call event, and the connection at the top of the filtered sorted list is utilized as the preferred connection for calls. Preferred status may be persisted until the next execution of the methodology when a potentially different connection is selected as preferred.

### BACKGROUND

Hybrid service networks typically allow phones and other devices to use one of multiple connections to a hybrid network at any time, for example using a connection over cellular circuit-switched network, a connection over cellular data network, or a connection over Wi-Fi network, etc. When a user places a new call or accepts an incoming call, a single connection needs to be selected from these multiple possible connections. This selection process can be complex since a variety of factors can influence the selection decision.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A methodology for automatic selection of a connection, on behalf of a device user, to a hybrid network for calls is provided in which a combination of a variety of inputs is utilized to populate a filtered list of available connections that is sorted using a variety of factors including connection cost with the less costly connections being populated towards the top of the list. The methodology is executed periodically, or in response to event occurrence such as a call event, and the connection at the top of the filtered sorted list is utilized as the preferred connection for calls. Preferred status may be persisted until the next execution of the methodology when a potentially different connection is selected as preferred.

In various illustrative examples, the connection selection methodology is run on a local mobile device using a connection selection component that may be implemented in a phone application or operating system functionality. The local connection selection component runs the methodology to select a preferred connection to a hybrid network which the device uses when placing outgoing calls. The preferred connection may be communicated, for example using signaling that is associated with incoming call acceptance, to a remote connection selection service which is supported using a network element located in the hybrid network. The hybrid network can then use the communicated preferred connection when completing the incoming call to the local mobile device.

In another illustrative example the local connection selection component can periodically, or in response to events, collect and communicate input data to the remote connection selection service. The remote connection selection service may use the communicated input data and run the methodology remotely from the local mobile device to identify the preferred connection which the hybrid network uses to route incoming calls to the mobile device. The preferred connection is communicated to a local connection selection component which the phone application on the mobile device uses when placing outgoing calls.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative telecommunications environment in which devices having telephony capabilities communicate over a hybrid communications network;

FIG. 2 shows an illustrative example of connection types over which a particular mobile device may access a hybrid communications network;

FIG. 3 shows an illustrative example in which outgoing calls are placed over a preferred connection by a mobile device and incoming calls are routed by a hybrid network over a preferred connection;

FIG. 4 shows an illustrative example in which a call is carried over multiple types of communications networks;

FIG. 5 shows an illustrative example in which a call is handed off between two different networks;

FIG. 6 shows an illustrative layered software architecture used on a mobile device that may be used to implement various aspects of the present connection selection in hybrid networks;

FIG. 7 shows a flowchart of an illustrative method that may be used by a connection selection component that operates on a local device;

FIG. 8 shows a taxonomy of illustrative inputs that may be utilized by a local connection selection component and a remote connection selection service;

FIGS. 9, 9A, and 9B show a flowchart of an illustrative methodology that may be utilized when selecting a connection for an outgoing call from a device;

FIGS. 10 and 10A show flowcharts of illustrative methods that may be utilized for handling an incoming call over a hybrid network;

FIG. 11 shows a flowchart of an illustrative method that may be performed by combination of a local connection selection component and a remote connection selection service;

FIG. 12 is a simplified block diagram of an illustrative computer system such as a personal computer (PC) that may be used in part to implement the present connection selection in hybrid networks;

FIG. 13 shows a block diagram of an illustrative device that may be used in part to implement the present connection selection in hybrid networks; and

FIG. 14 is a block diagram of an illustrative mobile device.

Like reference numerals indicate like elements in the drawings. Elements are not drawn to scale unless otherwise indicated.

### DETAILED DESCRIPTION

Mobile devices such as feature phones, laptop computers, tablets, and smartphones may have access over a variety of connections to multiple different service networks such as Wi-Fi, cellular, and other networks. Generally, a given network is only accessible using a single connection. In such a scenario, the user of the device manually chooses a network for his/her call and the connection selection follows directly from this manual choice. For example, when accessing a cellular network, the user picks a cellular connection since there are no other options. When accessing a VoIP (Voice over Internet Protocol) network, the user may choose from a Wi-Fi connection or a cellular data connection, but generally does not know which connection is better. Since a user typically has limited knowledge of the situation, it can often be hard for users to make an informed and good decision. As a result users can end up making a poor choice with a variety of undesirable consequences.

The process of selecting a connection for an incoming call or an outgoing call in a hybrid network is referred to here as “connection selection.” Each connection is typically capable of allowing the phone to access one or more services offered by the hybrid network. For example, some connections may only support audio calling, others may also support low definition video calling, and others may support high definition audio and video calling, etc. Different connections can also offer different ranges of mobility to the user of the phone. For example, Wi-Fi connections typically offer a relatively small range, while cellular circuit-switched connections offer a larger range. Different connections also offer different levels of reliability and quality of service and can vary in cost per usage.

The present connection selection in hybrid networks employs a methodology which is designed to enable a device to automatically select one of the available connections whenever the user places an outgoing call or accepts an incoming call. Typically using this methodology, the device will choose a connection that has the least cost but still provides a reliable call with acceptable quality to the user.

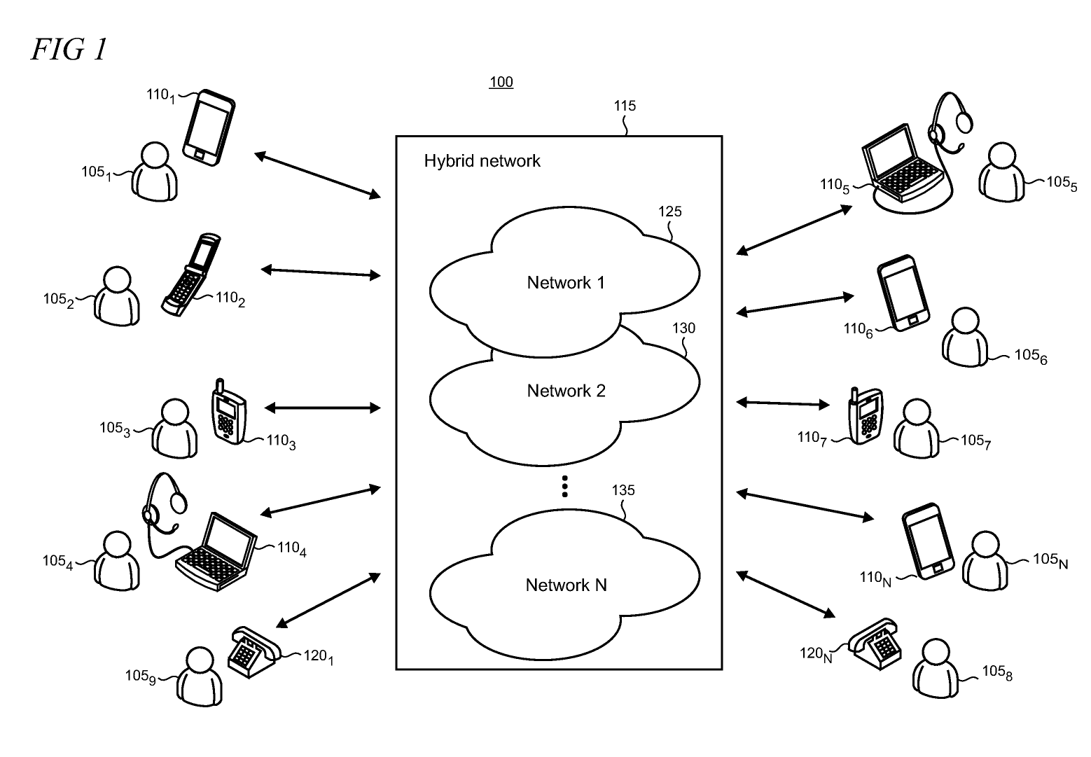

Turning now to the drawings, FIG. 1 shows an illustrative telecommunications environment 100 in which various users 105 employ respective mobile devices 110 that communicate over a hybrid communications network 115. The mobile devices 110 provide voice telephony capabilities and typically support data-consuming applications such as Internet browsing and multimedia (e.g., music, video, etc.) consumption in addition to various other features. The mobile devices 110 may include, for example, user equipment, mobile phones, cell phones, and smartphones which users often employ to make and receive voice and/or multimedia calls. However, alternative types of electronic devices are also envisioned to be usable within the telecommunications environment 100 so long as they are configured with telephony capabilities and can connect to the hybrid communications network 115, as described in more detail below. Such alternative devices variously include handheld computing devices, PDAs, portable media players, wearable computers, navigation devices such as GPS (Global Positioning System) systems, laptop PCs (personal computers), desktop computers, multimedia consoles, gaming systems, or the like. In the discussion that follows, the use of the term “mobile device” is intended to cover all devices that are configured with telephony capabilities and are capable of wired or wireless connectivity to the hybrid communications network 115.

Other types of telephony equipment may also be present in the telecommunications environment 100 such as conventional desktop phones 120 which are operatively coupled to a public switched telephone network (PSTN). Other examples may include equipment that connects to the PSTN using private branch exchanges (PBXs) and equipment coupled to call services that are accessed using telephone numbers.

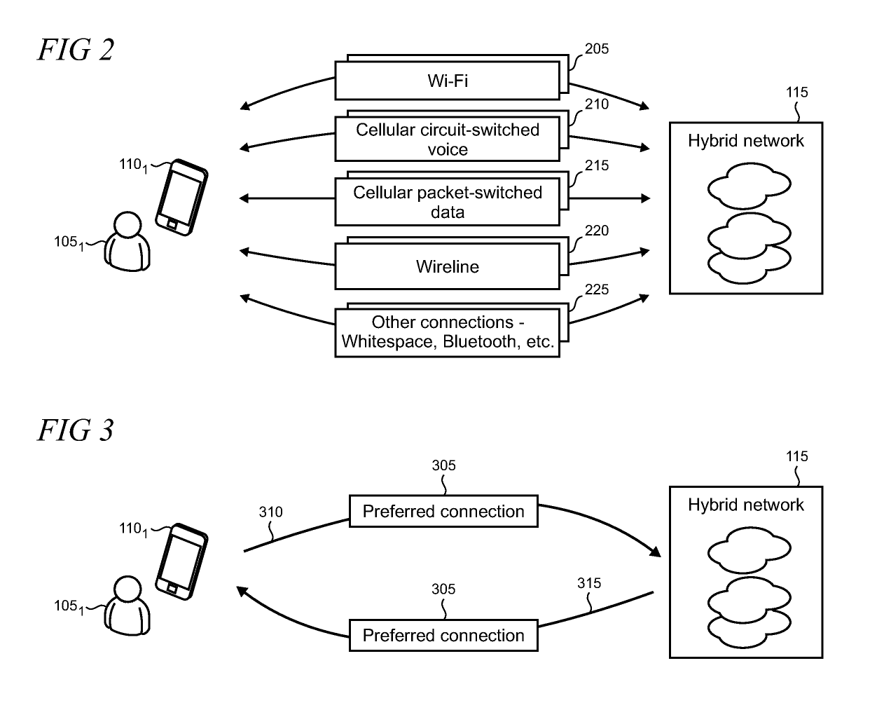

The hybrid communications network 115 comprises several networks 1, 2 . . . N, identified in FIG. 1 by reference numerals 125, 130, and 135, respectively. Typically, the various networks will be accessed using different types of wireless connections. For example, as shown in FIG. 2, the connection types may illustratively include Wi-Fi 205 that can support data and voice calls over VoIP, cellular circuit-switched voice 210, cellular packet-switched data 215, wireline 220 such as Ethernet and PSTN, and various other connections 225 such as Whitespace, Bluetooth, and the like. In some cases, multiple instances of a given connection may be present. For example, a mobile device 110 may have access to different Wi-Fi access points or “hot spots” and/or be able to use multiple different mobile data connections using multiple SIM (Subscriber Identification Module) cards. In an illustrative example, the networks in the hybrid communications network 115 may include a VoIP core network and a mobile operator (MO) network which typically includes an access network portion and a core network portion that provides for switching, routing, transport, and other functionalities. A PSTN wireline network may also be included as part of the hybrid communications network in some implementations, as discussed in more detail below.

As shown in FIG. 3, the present arrangement for connection selection in hybrid networks identifies a preferred connection 305 among the available connections to the hybrid network 115 from a mobile device 110. The preferred connection 305 can be used for outgoing calls 310 from the mobile device and also be used by the hybrid network to route incoming calls 315 to the mobile device. Typically the same connection is preferred for both outgoing and incoming calls, however, in some scenarios one connection may be preferred for outgoing calls and a different connection may be preferred for incoming calls.

Each mobile device 110 will typically have a prearranged association with one or more of the networks underlying the hybrid communications network 115. For example, a user 105 can be a subscriber to a cellular telephone service so that the user's mobile device 110 can access a given cellular network as valid and authenticated user equipment. Similarly, the mobile device 110 may include functionality and any needed credentials to access a Wi-Fi network. The mobile devices 110 may also interoperate with a VoIP network and be capable of providing voice call continuity (VCC) across different connection types according to a prearranged association. Such mobile devices are considered “VCC-equipped” and can access the hybrid communications network 115 over the different types of connections.

In some situations, a mobile device 110 may be placed in a dock or cradle that is coupled to the PSTN or other wireline local area networks (LANs) such as Ethernet networks and thus could employ a wireline connection for a call which is often the least expensive network connection. Typically, the mobile devices 110 use the less expensive Wi-Fi connection whenever it is available and capable of providing a reasonable level of call quality. When Wi-Fi is not available or is inadequate for the voice call, the call may be made over one of the other available network connection options after determining that the selected connection will result in acceptable call quality. Cellular voice is typically the costliest connection alternative but also the most ubiquitous and so it is used to ensure that the user has access to calling services from as wide an area as possible. In the description that follows, the mobile devices 110 are considered to be VCC equipped unless otherwise indicated.

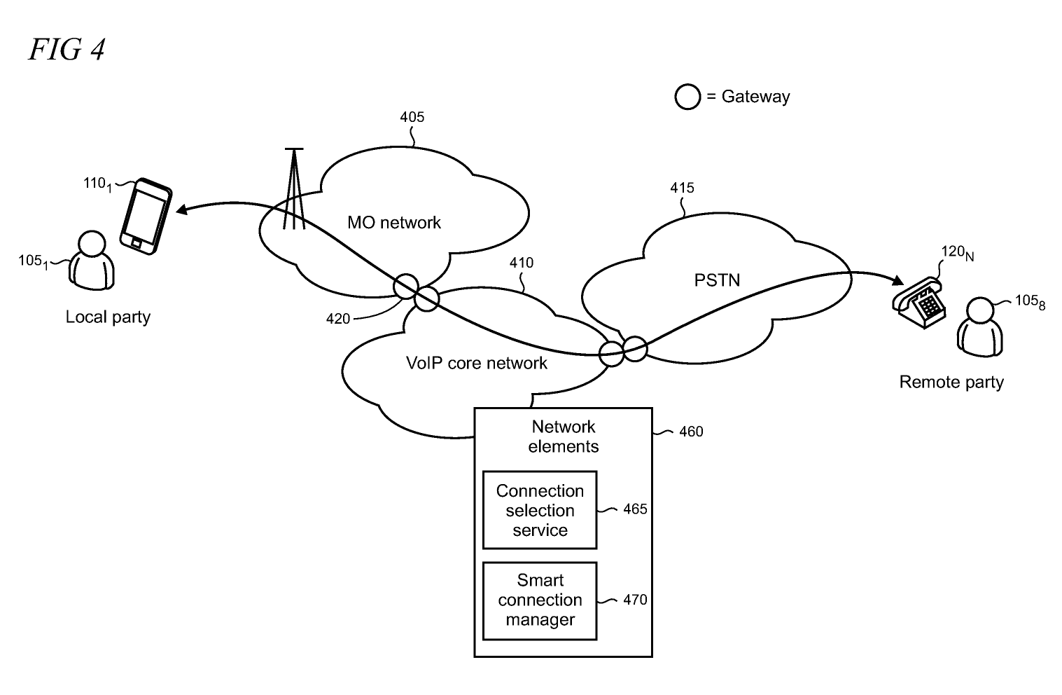

A characteristic of the hybrid communications network 115 is that two or more of the underlying networks (e.g., networks 125, 130, 135) are considered loosely coupled. That is, in one illustrative example, the VoIP network and the MO network are typically operated independently so that one network cannot exercise significant or substantial control over the operation of the other. However, as shown in FIG. 4, the underlying networks, while loosely coupled, are still interoperable so that calls can traverse an MO network 405, VoIP core network 410, and PSTN 415. Such interoperability is commonly facilitated using gateways, as representatively indicated by reference numeral 420. It is becoming increasingly common for significant portions of a given call to be transported over the VoIP core network 410 because such networks can often provide very high quality transport at the lowest cost to the network operators. In such cases, the MO network 405 and the PSTN network 415 essentially function as access networks to the mobile device at each end of the call while the VoIP core network 410 performs the bulk of the routing and transport for the call. Other access networks may also be utilized in order for a call to reach the VoIP core network 410 including both cellular circuit-switched and packet-switched networks, and Wi-Fi access points (APs) such as public Wi-Fi hotspots and those provided by home and office Internet Service Providers (ISPs).

FIG. 4 also shows network elements 460 that are instantiated in the VoIP core network 410. The network elements 460 can be configured and utilized to support various features in the hybrid communications network. In addition, the network elements 460 can expose a connection selection service 465 and a smart connection manager 470 which are described in more detail below.

While the network hybridization described above can provide cost-effective and high quality transport, the loose coupling has traditionally presented difficulties for voice call continuity. Voice call continuity functionality is defined here as the maintenance of ongoing voice calls for a device that is capable of placing and receiving voice calls in the face of changes in prevailing connection conditions perhaps due to user mobility or other environmental factors. For example, the connection currently being used, such as Wi-Fi under IEEE (Institute of Electrical and Electronic Engineers) 802.11 could start demonstrating worsening radio signal and/or network congestion conditions, or the user could move to a location where the Wi-Fi connection does not work at all. In addition, other connection options may become available that are lower cost, or provide a better user experience, and therefore either or both the user and network operator may wish to utilize such connection options.

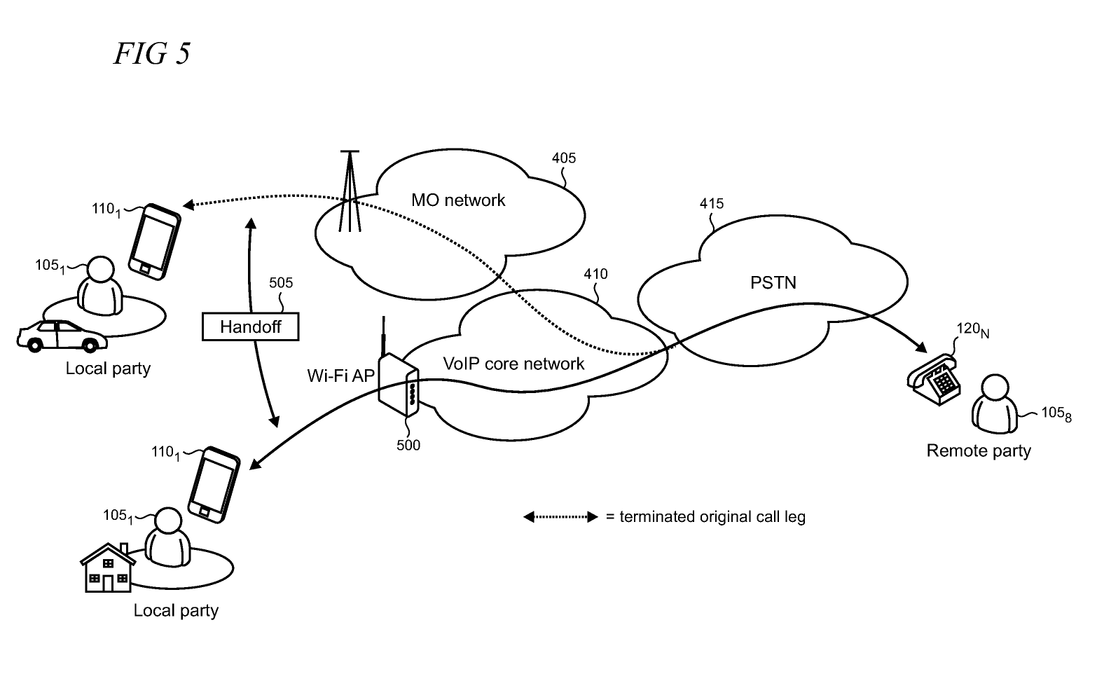

For example, as shown in FIG. 5, a user 105 may be in the car when initiating a call over the MO network 405. When the user 105 returns home, another call leg is then created over a selected connection which in this example is the home Wi-Fi connection via a Wi-Fi access point (AP) 500 to the VoIP core network 410. The selected connection is associated with the call, preferably while the original call is still ongoing (in what is termed a “make-before-break” handoff). When the new call leg is stable, the original call leg is removed from the call and the handoff 505 to the new connection is complete.

If the handoff is initiated so that both the original and newly selected connections are operative simultaneously then there will be an intermediate state in which both call legs will be running in parallel. Media flows can be directed to and from the mobile device over these parallel connections, until one of the two flows is terminated. Such intermediate state enables the call to be maintained in an uninterrupted manner as perceived by the parties on both ends of the call. During the intermediate state, the mobile device can typically choose to connect to one of the two flows as it deems appropriate.

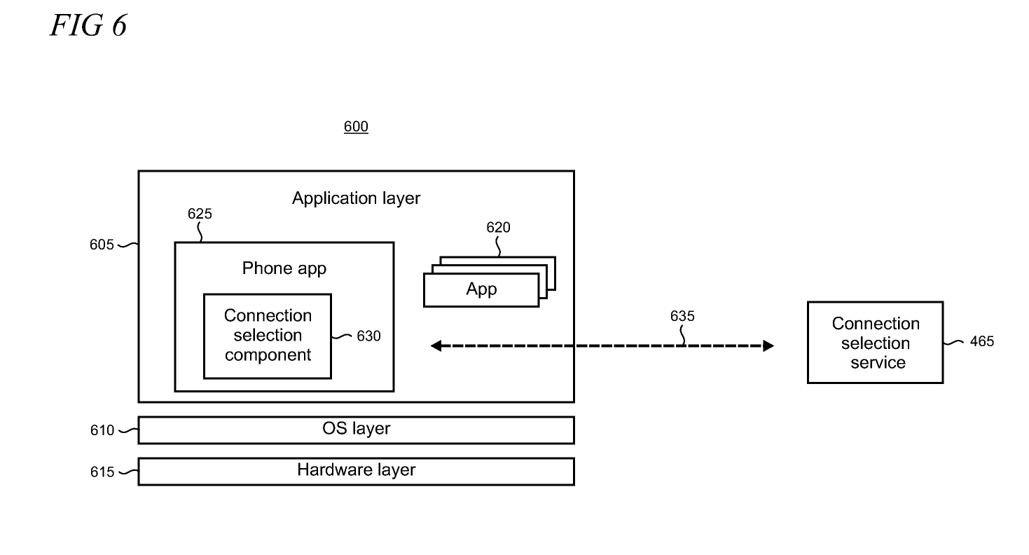

As shown in FIG. 6, a mobile device 110 can support a layered architecture 600 of functional components. The architecture 600 is typically implemented in software, although combinations of software, firmware, and/or hardware may also be utilized in some cases. The architecture 600 is arranged in layers and includes an application layer 605, an OS (operating system) layer 610, and a hardware layer 615. The hardware layer 615 provides an abstraction of the various hardware used by the mobile device 110 (e.g., input and output devices, networking and radio hardware, etc.) to the layers above it.

The application layer 605 in this illustrative example supports various applications 620 that expose various features and user experiences as well as a phone application 625. The phone app 625 includes a connection selection component 630 supporting functionality described in more detail below. The applications 620 and 625 are often implemented using locally executing code. However in some cases the applications may rely on services and/or remote code execution provided by remote servers or other computing platforms such as those supported by an external service provider. While the connection selection component 630 is shown here as a part of the phone app that is instantiated in the application layer 605, it may be appreciated that the functionality provided by the component may be implemented, in whole or part, using components that are supported in either the OS or hardware layers or spread among the application, OS, and/or hardware layers in some cases. The connection selection component 630 on a local mobile device 110 may also interact with the remote connection selection service 465 in some scenarios as indicated by line 635.

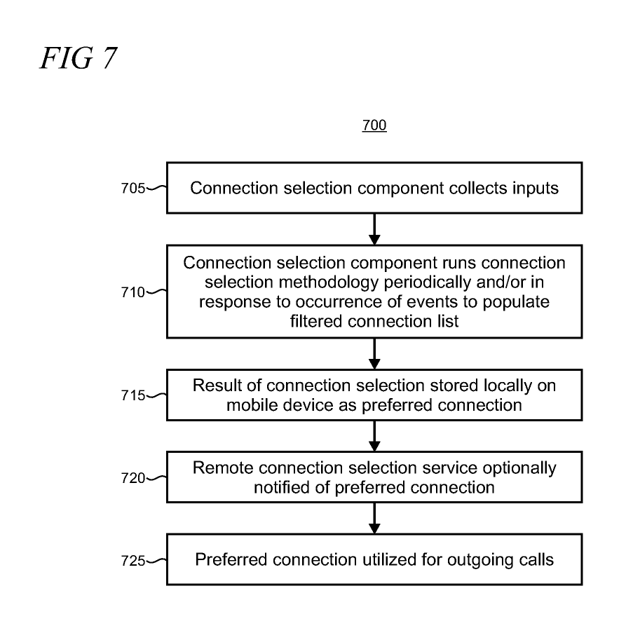

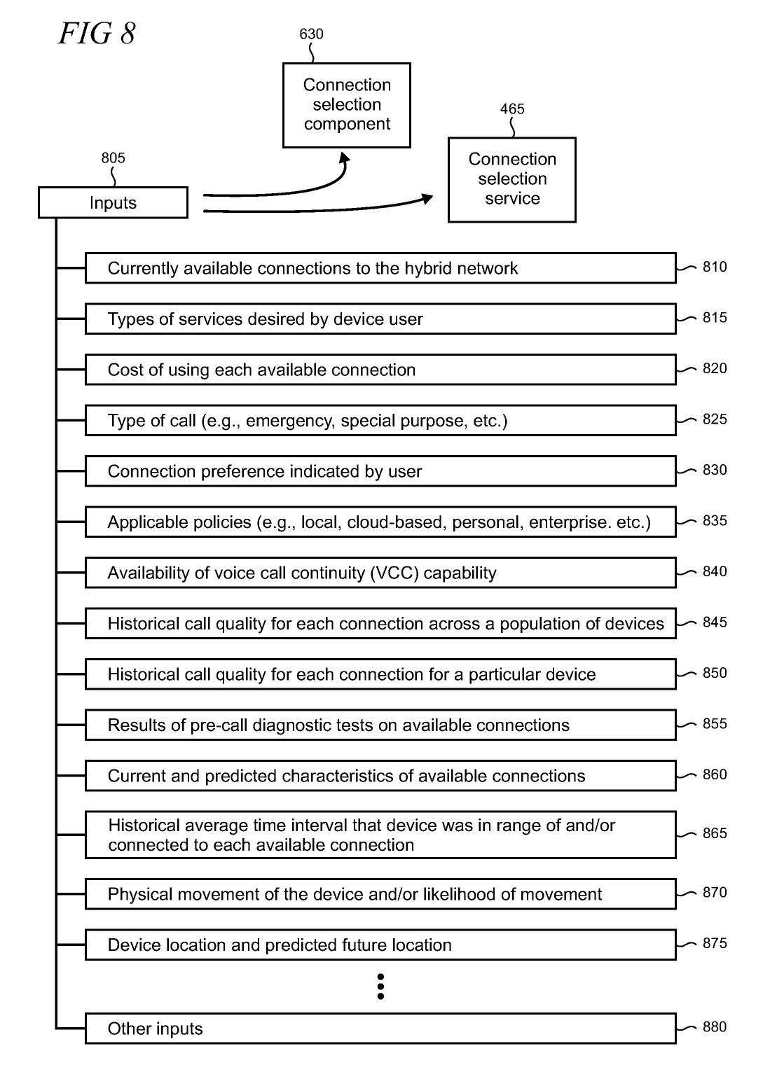

FIG. 7 shows a flowchart of an illustrative method 700 that may be used by the connection selection component 630 that operates on a local mobile device 110. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 705, various inputs (described in the text accompanying FIG. 8 below) are collected that may be utilized by a connection selection methodology, such as an algorithm, process, or computation that the component 630 (and/or service 465) can execute. The inputs can be collected by the connection selection component 630 at the local mobile device and/or at the connection selection service 465 in some implementations. The connection selection component 630 may run the connection selection methodology periodically and/or in response to the occurrence of events in step 710. Such events may include, for example, initiation of an outgoing phone call by the user.

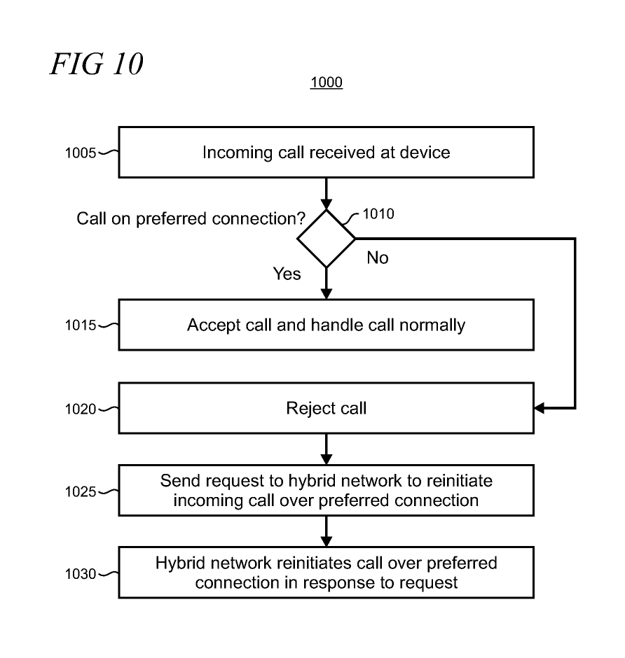

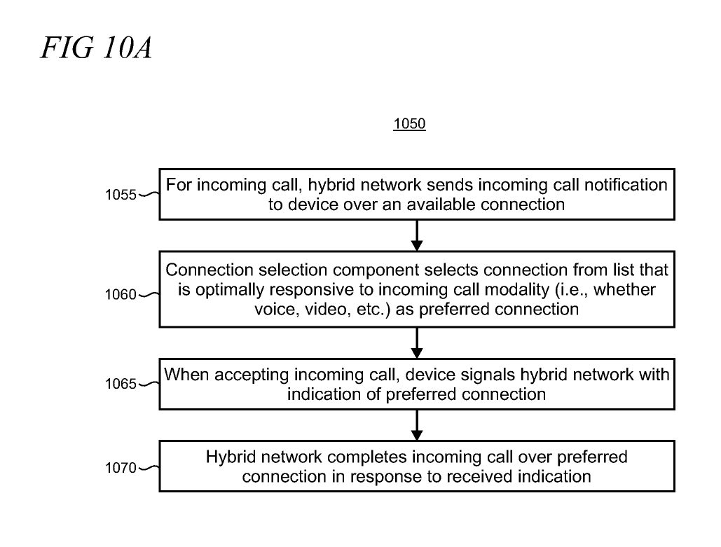

The result of the connection selection methodology may be locally stored on the mobile device by the component 630 as the preferred connection 305 (FIG. 3) in step 715. Preferred connection status is typically persisted until the next occurrence of selection methodology execution when potentially a different connection is selected as the preferred connection. The local connection selection component 630 can optionally notify the remote connection selection service 465 of the preferred connection in step 720. In step 725, the phone app 625 on the local mobile device 110 can use the preferred connection 305 when making an outgoing call. In some implementations the hybrid network 115 can use the preferred connection 305 when routing an incoming call to the local mobile device 110. Other ways of handling incoming calls are described below in the text accompanying FIGS. 10 and 10A.

FIG. 8 shows a taxonomy of illustrative inputs 805 that may be utilized by the connection selection component 630 on a local device 110 and the remote connection selection service 465 when running the connection selection methodology. It is emphasized that the inputs 805 shown and described are intended to be illustrative and not exhaustive. Not all of the inputs need to be used in a given implementation of the present connection selection and different combinations of inputs can be respectively utilized by the locally executing connection selection component 630 and remote connection selection service 465.

Currently available connections to the hybrid network 810 comprise the connections of various types that are available to a given mobile device 110. Illustrative examples of connection types include cellular circuit-switched, cellular data, Wi-Fi, White Space, Bluetooth, wireline, and the like. One or more of such connections may provide access to the hybrid network 115. Note that the access to the hybrid network's VoIP core 410 (FIG. 4) may be provided through other networks. For example, a cellular circuit switched connection will go through the cellular circuit-switched network before reaching the VoIP 410 core of the hybrid network 115. Different connections might go through different networks and still connect to the hybrid network VoIP core. From the point of view of the mobile device 110, different connections provide different “paths” to the hybrid network VoIP core 410.

The types of services desired by a device user 815 is an input that takes into account that not all connections between the mobile device 110 and hybrid network 115 support all the services that may be supported by the hybrid network. Accordingly, having knowledge of the services desired by the user can be used to exclude those connections that are not capable of supporting the desired service type. For example, as noted above, a given connection may not support a high definition video call that the user desires to place.

The cost of using each available connection 820 is an input that recognizes the typical user's expectation that the least expensive connection that provides the desired service be utilized. Generally, Wi-Fi connections provide the least expensive wireless access to the hybrid network 115 and cellular data connections provide the next least expensive access. Cellular circuit-switched connections generally provide the most expensive access to the hybrid network 115. In typical implementations, however, the cost of using a given connection can change dynamically depending on a number of factors. For example, the cost of using a cellular data connection often depends on whether the phone is using its “home” cellular network or is roaming on a visited network. Similarly, a particular Wi-Fi connection could be metered and its usage cost might be high.

The type of call input 825 includes emergency and other special purpose calls. Certain connections may typically be better suited for emergency and special purpose calls. For example, cellular circuit-switched connections are in general better for emergency and special purpose calls compared to other connection types because they more readily ensure interruption-free calls in the face of user mobility. Thus, the knowledge of whether special purpose calls are in progress or if a special purpose call is being initiated or received, can be factored into the connection selection methodology to pick an appropriate connection. In some cases, multiple connections may be used one after another. For example, an emergency call can be dialed over cellular circuit-switched connection first and if that fails, then it can be placed over Wi-Fi connection. An emergency call can also be skewed where the call is dialed over cellular circuit-switched connection first and over Wi-Fi connection later (e.g., several seconds later) if the first call is still attempting to connect and has not succeeded so far. Connections may also be initiated simultaneously where the call can be dialed over cellular circuit-switched connection and Wi-Fi connection at substantially the same time to enhance chances of connecting the call.

If the mobile device user has expressed a connection preference, then the preference may be used as an input 830. For example, in some cases the user may know that he or she is soon going to move to a different location but there might be no other indication that such movement is imminent and therefore some connections may be lost. In other cases, the user prefers a certain connection because it has historically provided better reliability or quality at that particular place. Alternatively, the user may be making an especially important call and wants to override any considerations of cost savings. In another situation, the user may prefer a given connection because of its low cost even though there is some reliability/quality risk in using that particular connection.

A variety of applicable policies 835 may dictate the selection of connections in specific circumstances. Such policies can be sourced locally or be cloud-based and pertain to personal and/or job-related (i.e., enterprise) matters. For example, a given policy may require that when a call is made to a set of destination numbers, a specific set of connections should be used. Such policies may be configured on the mobile device 110 by the hybrid network 115, the user 105, or other entities such an enterprise/information technology administrator in some cases.

The availability of VCC capabilities 840 may be a consideration in eliminating some connections from being preferred in some instances. For example, a mobile device may be roaming on a visited MO network so VCC may not be available. In such cases, a transport such as Wi-Fi that has a narrow coverage area would typically not be selected as a preferred connection.

The historical call quality for each connection across a population of devices may be implemented as an input 845 using, for example, a cloud-based smart connection manager 470 (FIG. 4). The smart connection manager 470 may be configured to continually evaluate a variety of crowd-sourced data which may include call quality estimates from past calls and other such data. The smart connection manager can compute the expected call quality for each connection instance as seen by a population of mobile devices 110 over time. For example, the smart connection manager 470 can compute an expected call quality for a specific Wi-Fi network at a given time interval during the day. The connection selection methodology can use this historical call quality information to estimate the call quality a device can expect to experience from each of its currently available connections.

The historical call quality for each connection for a particular mobile device may be implemented as an input 850. While the smart connection manager computes call quality for connections based on the data it receives from a population of devices over time, the connection selection component running on a particular mobile device can also maintain a historical record of call quality that it has experienced for each instance of connections used. As with the crowd-sourced data, the particular device information may be factored into estimates of call quality for future calls on a particular connection instance.

The connection selection component 630 may run a host of tests on each instance of connections available to it and the test results used as an input 855. For example, the mobile device may make a test call over the Wi-Fi network to which it is currently connected to measure call quality characteristics. This test call may be performed as a background task without the awareness or involvement of the user in many cases. Such tests may also be referred to as pre-call diagnostics.

With the current and predicted characteristics of available connections 860, the connection selection component 630 on a mobile device may continuously monitor transport and radio characteristics of the connections that are currently available to it. Such data allows the device to monitor and predict the suitability of each connection as a preferred connection. For example, for each Wi-Fi connection, the connection selection component 630 can monitor metrics such as RSSI (Relative Signal Strength Indicator), transmission rate, error rate of the Wi-Fi network, data link rates, and the like. If such metrics indicate that the Wi-Fi connection quality is dropping, the connection selection methodology can be rerun in some instances and that particular Wi-Fi connection could be excluded from being a candidate for the preferred connection.

The historical average time interval that a mobile device 110 was in range of and/or connected to each available connection 865 may be an indicator of whether the connection is a transient connection or a more permanent connection. For example, the device is likely to be connected to the user's home Wi-Fi network for significantly longer durations of time than to the Wi-Fi network in the grocery store where the user shops. If the mobile device 110 is connected to the user's Wi-Fi network, the Wi-Fi connection might be suitable as compared to when the device is connected to the grocery store Wi-Fi network where the Wi-Fi connection might be less suitable because it would likely be a more temporary connection that could become unavailable in a short time when the user finishes shopping.

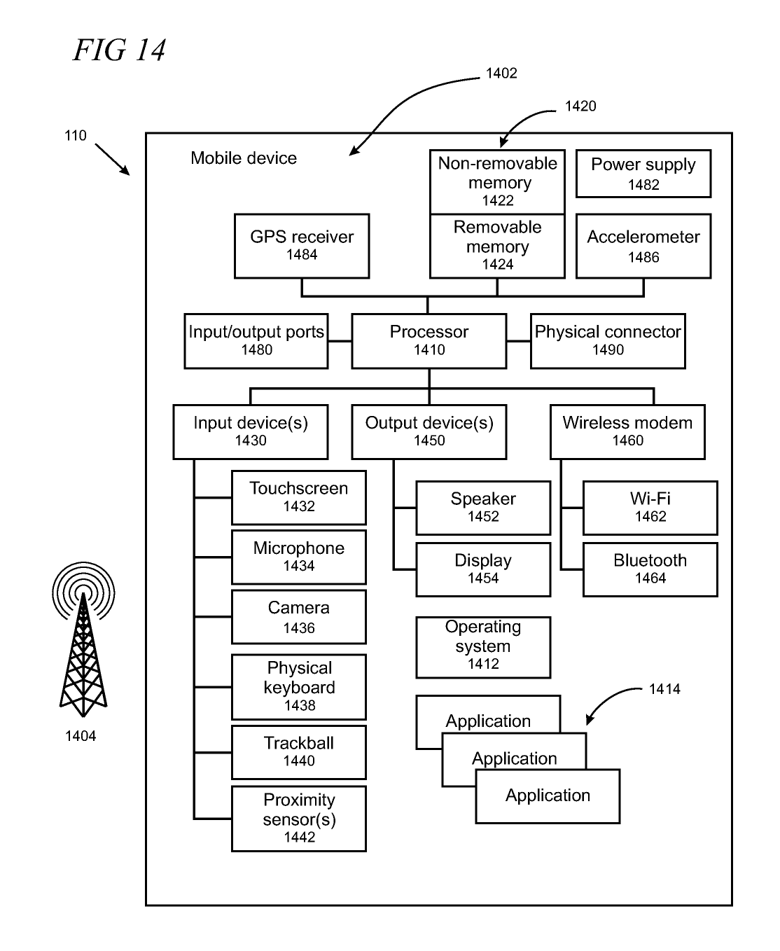

A mobile device has a number of sensors that can be used to determine the location of the user and whether the phone is physically moving or stationary (as shown in FIG. 14 and described in the accompanying text). Thus, the physical movement of a mobile device and/or its likelihood of movement may be utilized as an input 870 in some cases. For example, GPS can be used to determine whether the user is at home or at work. An accelerometer and other inertial sensors can be used to detect if the mobile device is moving or stationary and the nature of the movement, whether it be walking, running, and so on. Short range communication protocols such as Bluetooth can be used to determine whether the mobile device 110 is connected to a car Bluetooth system, thus increasing the chance of the user imminently driving away from any currently available Wi-Fi connections. This sensor-based information can be used to infer if the user is moving or will be moving soon. For a moving user, a long range connection such as a cellular circuit-switched connection may be a better option than a short range connection such as a Wi-Fi connection. However, in some instances in which a Wi-Fi connection is associated with a transportation vehicle such as an airplane or a bus, the Wi-Fi connection might continue to be a viable option as a preferred connection as well despite the association with user mobility.

With device location 875, it may be possible to deduce if the mobile device 110 will lose access in the future to one or more connections to the hybrid network 115. For example, if the user is at home but he or she has a meeting scheduled at work in 30 minutes, it is likely that the user will be travelling to work and will lose access to the home network soon. Historical knowledge of the location of the user's home and place of the upcoming appointment can be utilized as well to estimate travel time and the associated risk of loss of home network access. The connection selection methodology can advantageously leverage this information by not selecting the home Wi-Fi connection as the preferred connection in a time interval that is close to the expected appointment.

Other inputs 880 may also be utilized to meet the needs of a particular implementation of the present connection selection in hybrid networks.

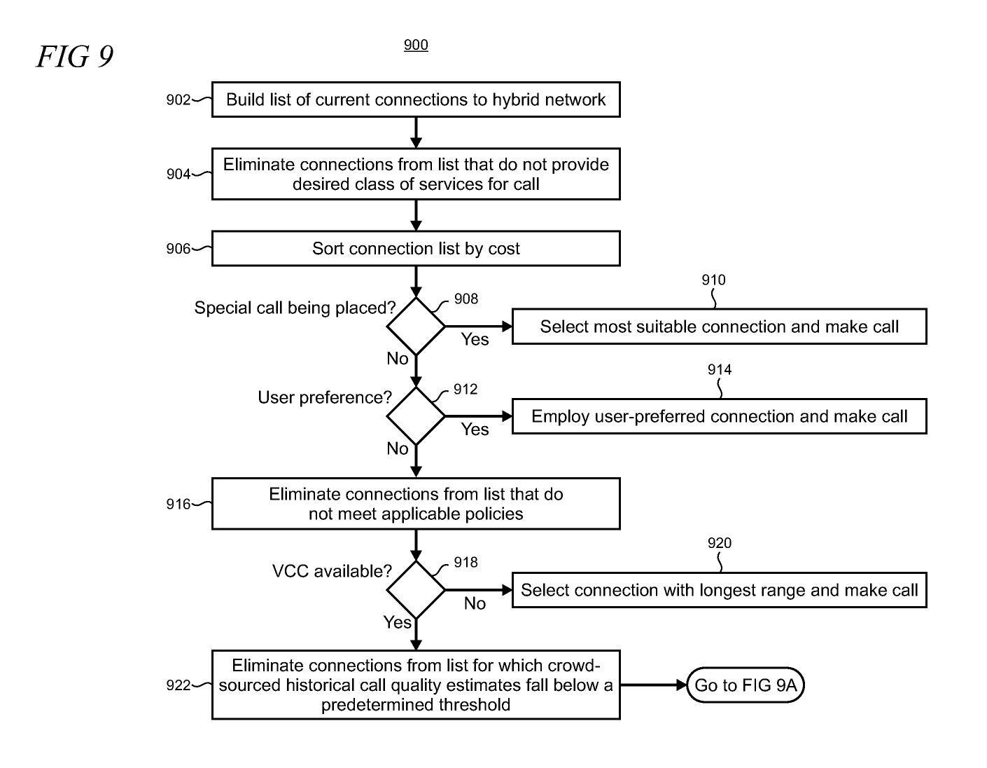

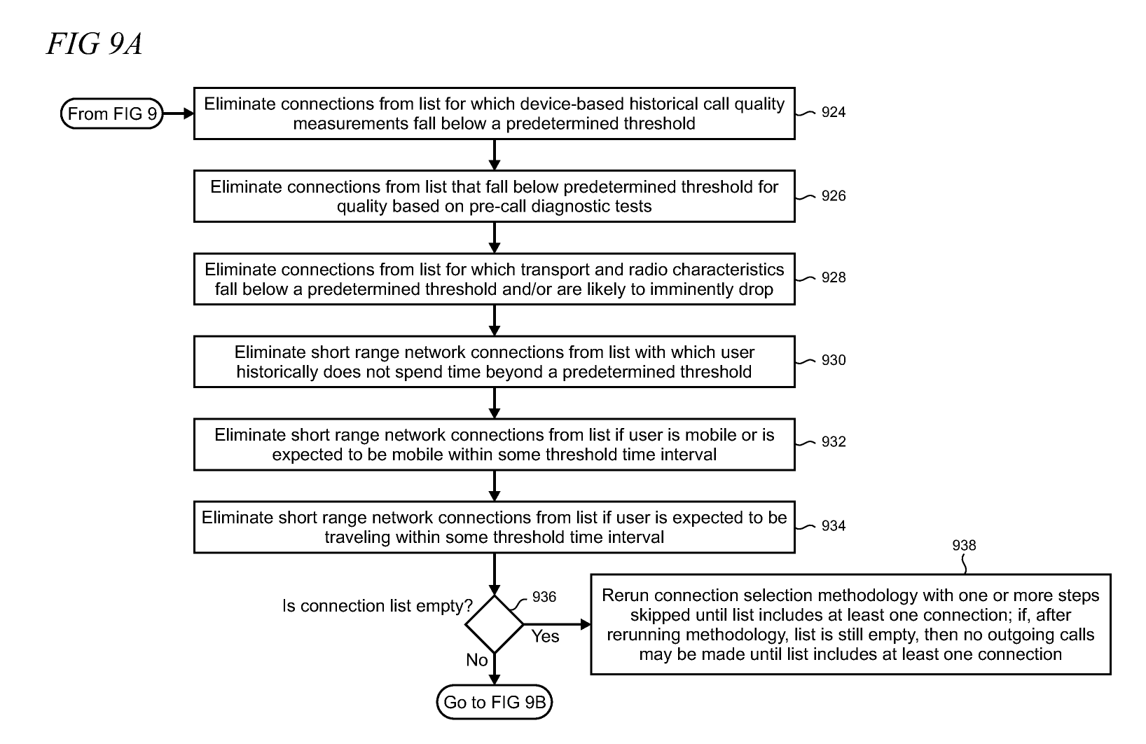

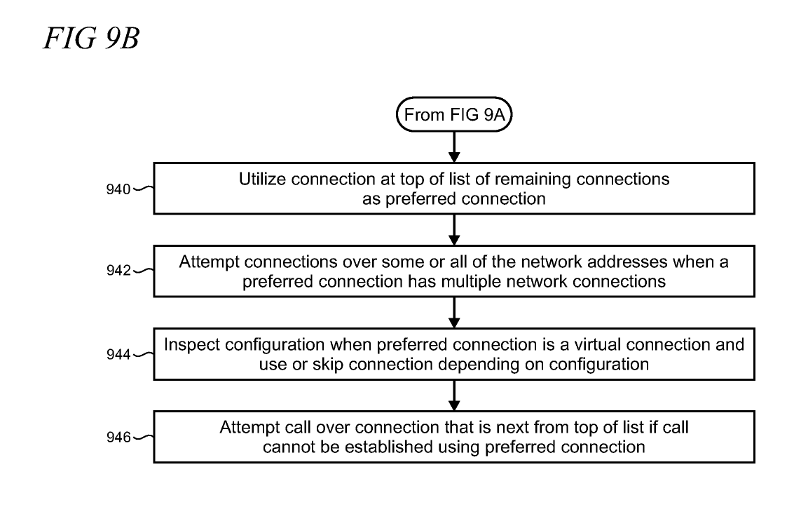

FIGS. 9, 9A, and 9B show a flowchart of illustrative steps that may be implemented by the connection selection methodology 900 when run by the local connection selection component 630 for selecting a connection for an outgoing call from a mobile device 110. A modified implementation of the connection selection methodology that may be run for incoming calls by the remote connection selection service 465 is similar except for some differences. A modified implementation of the connection selection methodology that may be run by either the component 630 or service 465 when there are no currently active calls is also similar except for some differences. Such differences are described in more detail below after the description of the methodology in its entirety.

In step 902, a list of current connections that provide access from the mobile device 110 to the hybrid network 115 is built. In step 904, connections that do not provide a desired class of services for the call are eliminated from the built connection list. In step 906, the connection list is sorted in increasing order of their usage costs with the least expensive connection being first and most expensive connection being last.

At decision block 908, if a special call (e.g., an emergency call) is being placed, then the most suitable connection from the list is selected and the call is made in step 910. If the outgoing call is not a special call, then at decision block 912, if the user has expressed a connection preference (e.g., having provided an input or set a preference through a user interface exposed by the component 630), then the user-preferred connection is selected from the connection list and the call is made in step 914. Otherwise, in step 916, connections that do not meet any applicable policies are eliminated from the connection list.

At decision block 918, if VCC is not available, then a connection with the longest range is picked from the list and the call is made in step 920. Otherwise, connections for which crowd-sourced historical estimates of call quality fall below a certain predetermined threshold are eliminated from the connection list in step 922. In step 924 (shown in FIG. 9A), connections for which device-based historical measurements of call quality fall below a certain predetermined threshold are eliminated from the connection list.

In step 926, connections that fall below a predetermined threshold for quality based on pre-call diagnostic tests are eliminated from the connection list. In step 928, connections for which transport and radio characteristics fall below a certain predetermined threshold and/or are likely to imminently drop based on trends are eliminated from the connection list. In step 930, short range network connections for which the user historically does not spend time beyond a certain predetermined threshold are eliminated from the connection list.

In step 932, short range network connections associated with the user when mobile or is expected to be mobile within some threshold time interval are eliminated from the connection list. In step 934, short range network connections associated with the user when traveling or expected to be traveling (determined using, for example, the user's calendar information and/or other data) within some threshold time interval are eliminated from the connection list.

At decision block 936, if the connection list is empty after completing the preceding elimination steps, then in step 938, the connection selection methodology may be rerun with one or more of the preceding steps skipped until the connection list includes at least one connection. In typical implementations, if no connections remain after skipping all of the preceding steps, then no outgoing calls can be made until the connection list becomes populated with at least one connection.

If the connection list is not empty, then in step 940 (shown in FIG. 9B) the connection on the top of the list may be utilized as the preferred connection for the outgoing call. If the preferred connection includes multiple network connections, then the outgoing call can be attempted using some or all of the network addresses associated with the preferred connection in step 942. In step 944, if the preferred connection is a virtual connection (such as a VPN (Virtual Private Network), a tunnel, etc.), then the connection selection methodology may use the connection or skip it depending on the connection's particular configuration. In step 946, if a call cannot be established over the preferred connection for some reason, then the next connection from the top of the list may be used as the preferred connection and the call may be retried over that connection in some cases.

A modified implementation of the connection selection methodology 900 for incoming calls can be similar to the flowchart discussed with the exception that steps 904, 908, 910, and 946 can typically be skipped. A modified implementation of the connection selection methodology 900 when there are no currently active calls can be similar to the flowchart discussed with the exception that steps 904, 908, 910, 916, 918, 920, and 946 can typically be skipped.

FIG. 10 shows a flowchart of an illustrative method 1000 that may be utilized by a given mobile device 110 when receiving an incoming call over the hybrid network 115. In step 1005, a call is received at the mobile device. At decision block 1010, if the call is on the preferred connection, then the mobile device will accept the call and handle it normally in step 1015. However, if the incoming call is not on the preferred connection, then in step 1020 the mobile device can reject the call and send a request to the hybrid network 115 to reinitiate the incoming call over the preferred connection in step 1025. The request can include an identification of the preferred connection in some cases. In step 1030, the hybrid network 115 can reinitiate the incoming call over the preferred connection in response to the request.

FIG. 10A shows a flowchart of an alternative method 1050 that may be utilized by a given mobile device 110 when receiving an incoming call over the hybrid network 115. When handling an incoming call for the mobile device, the hybrid network sends an incoming call notification to the device over an available connection in step 1055. For example, the incoming call notification may be carried over a connection with which the device is registered or associated such as a cellular connection (e.g., a circuit-switched or data-switched connection). Typically, the incoming call notification can include signaling that indicates the modality of the incoming call, that is, whether the call is a voice call or a video call, etc. Supplemental signaling to the incoming call notification may also be utilized to indicate call modality in some cases.

In step 1060, the connection selection component 630 on the device selects a connection from the connection list that is optimally responsive to the incoming call modality. For example, if the incoming call is a video call, the connection selection component 630 can select the connection that meets the bandwidth requirements as the preferred connection for the call that is highest on the connection list (and thus is the least expensive connection that provides the requisite quality of service).

In step 1065, when accepting the call, the device 110 may signal the hybrid network 115 with an indication of the preferred connection. Such indication can be part of the acceptance signaling in some cases, or be implemented using supplemental signaling in others. The hybrid network can complete the call over the preferred connection in response to the received indication in step 1070.

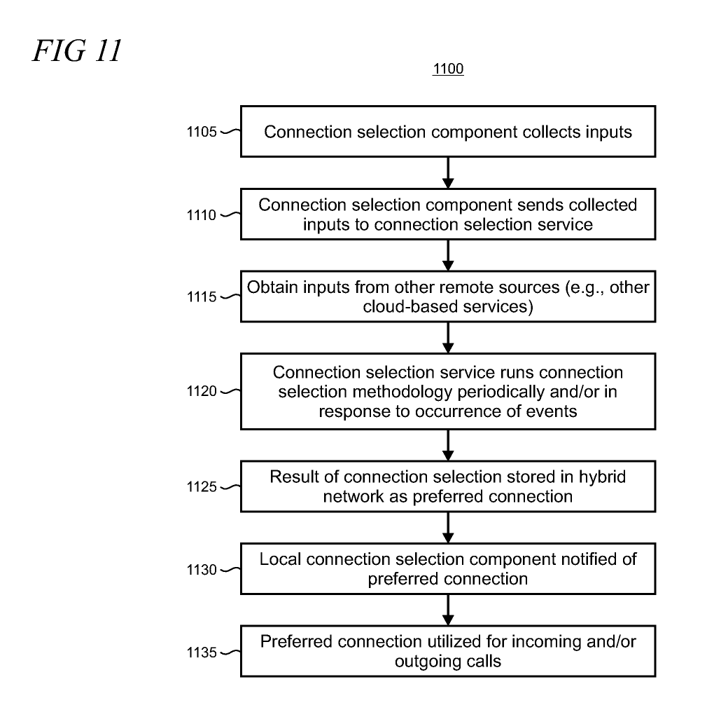

FIG. 11 shows a flowchart of an illustrative method 1100 that may be performed by combination of the local connection selection component 630 and the remote connection selection service 465. In step 1105, the connection selection component 630 collects inputs at the local mobile device 110. In step 1110, the connection selection component 630 sends the collected inputs to the remote connection selection service 465. The connection selection service can also obtain inputs from other sources in some cases, for example other cloud-based services and/or resources, in step 1115.

The connection selection service 465 can run the methodology 900 (FIGS. 9, 9A, and 9B), or a modified methodology in some cases periodically or in response to the occurrence of events using the collected inputs received from the component 630 in step 1120. The results of the application of the connection selection methodology may be stored in the hybrid network 115 as the preferred connection 305 (FIG. 3) in step 1125. Typically, preferred connection status is persisted until the next occurrence of selection methodology execution when potentially a different connection is selected as the preferred connection.

In step 1130, the connection selection component 630 on the local mobile device 110 is notified of the preferred connection 305. In step 1135, the phone app 625 on the local mobile device 110 can use the preferred connection 305 when making an outgoing call and the hybrid network 115 can use the preferred connection 305 when routing an incoming call to the local mobile device 110.

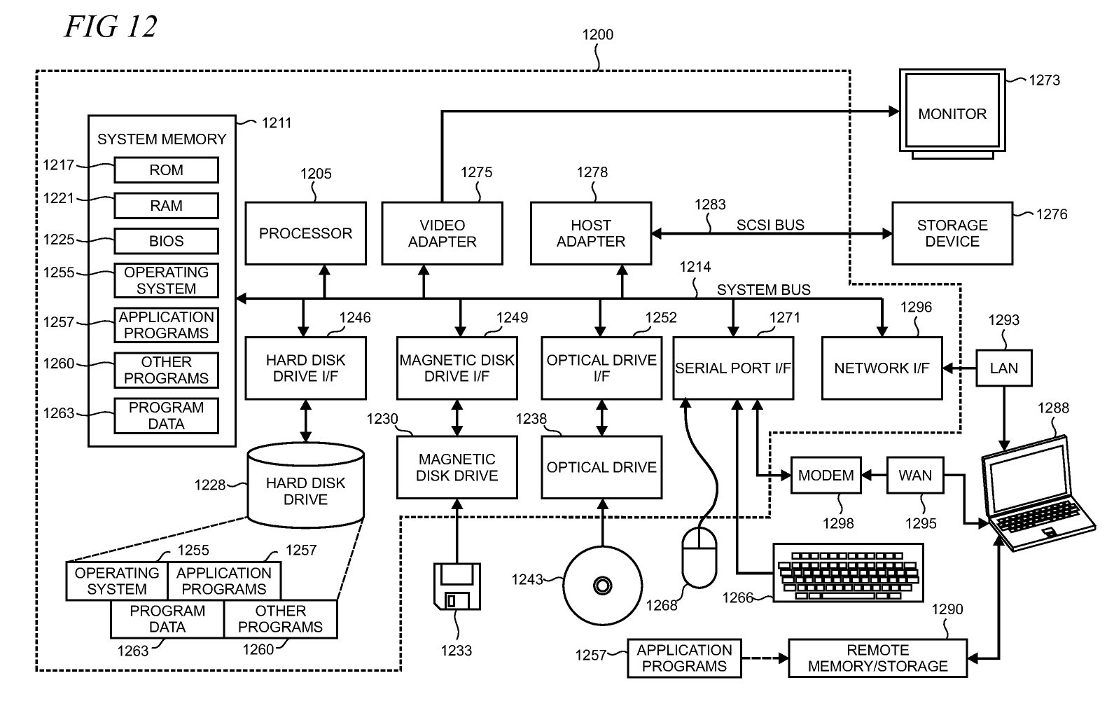

FIG. 12 is a simplified block diagram of an illustrative computer system 1200 such as a personal computer (PC), client machine, or server with which the present connection selection in hybrid networks may be implemented. For example, computer system 1200 may be utilized to support the network elements 460 (FIG. 4). Computer system 1200 includes a processor 1205, a system memory 1211, and a system bus 1214 that couples various system components including the system memory 1211 to the processor 1205. The system bus 1214 may be any of several types of bus structures including a memory bus or memory controller, a peripheral bus, or a local bus using any of a variety of bus architectures. The system memory 1211 includes read only memory (ROM) 1217 and random access memory (RAM) 1221. A basic input/output system (BIOS) 1225, containing the basic routines that help to transfer information between elements within the computer system 1200, such as during startup, is stored in ROM 1217. The computer system 1200 may further include a hard disk drive 1228 for reading from and writing to an internally disposed hard disk (not shown), a magnetic disk drive 1230 for reading from or writing to a removable magnetic disk 1233 (e.g., a floppy disk), and an optical disk drive 1238 for reading from or writing to a removable optical disk 1243 such as a CD (compact disc), DVD (digital versatile disc), or other optical media. The hard disk drive 1228, magnetic disk drive 1230, and optical disk drive 1238 are connected to the system bus 1214 by a hard disk drive interface 1246, a magnetic disk drive interface 1249, and an optical drive interface 1252, respectively. The drives and their associated computer-readable storage media provide non-volatile storage of computer-readable instructions, data structures, program modules, and other data for the computer system 1200. Although this illustrative example includes a hard disk, a removable magnetic disk 1233, and a removable optical disk 1243, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present connection selection in hybrid networks. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk 1228, magnetic disk 1233, optical disk 1243, ROM 1217, or RAM 1221, including an operating system 1255, one or more application programs 1257, other program modules 1260, and program data 1263. A user may enter commands and information into the computer system 1200 through input devices such as a keyboard 1266 and pointing device 1268 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 1205 through a serial port interface 1271 that is coupled to the system bus 1214, but may be connected by other interfaces, such as a parallel port, game port, or universal serial bus (USB). A monitor 1273 or other type of display device is also connected to the system bus 1214 via an interface, such as a video adapter 1275. In addition to the monitor 1273, personal computers typically include other peripheral output devices (not shown), such as speakers and printers. The illustrative example shown in FIG. 12 also includes a host adapter 1278, a Small Computer System Interface (SCSI) bus 1283, and an external storage device 1276 connected to the SCSI bus 1283.

The computer system 1200 is operable in a networked environment using logical connections to one or more remote computers, such as a remote computer 1288. The remote computer 1288 may be selected as another personal computer, a server, a router, a network PC, a peer device, or other common network node, and typically includes many or all of the elements described above relative to the computer system 1200, although only a single representative remote memory/storage device 1290 is shown in FIG. 12. The logical connections depicted in FIG. 12 include a local area network (LAN) 1293 and a wide area network (WAN) 1295. Such networking environments are often deployed, for example, in offices, enterprise-wide computer networks, intranets, and the Internet.

When used in a LAN networking environment, the computer system 1200 is connected to the local area network 1293 through a network interface or adapter 1296. When used in a WAN networking environment, the computer system 1200 typically includes a broadband modem 1298, network gateway, or other means for establishing communications over the wide area network 1295, such as the Internet. The broadband modem 1298, which may be internal or external, is connected to the system bus 1214 via a serial port interface 1271. In a networked environment, program modules related to the computer system 1200, or portions thereof, may be stored in the remote memory storage device 1290. It is noted that the network connections shown in FIG. 12 are illustrative and other means of establishing a communications link between the computers may be used depending on the specific requirements of an application of the present connection selection in hybrid networks.

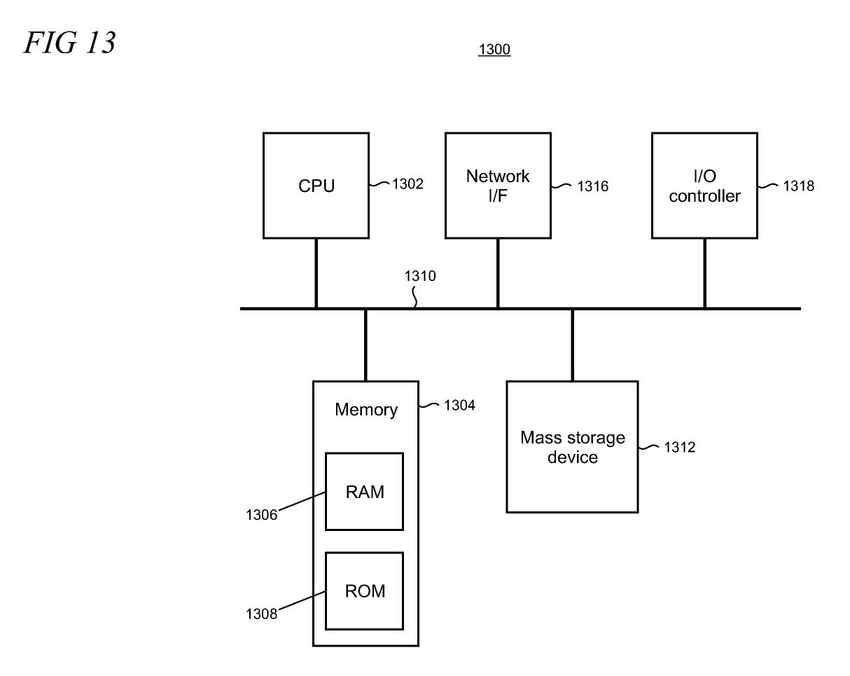

FIG. 13 shows an illustrative architecture 1300 for a device capable of executing the various components described herein for providing the present connection selection in hybrid networks. Thus, the architecture 1300 illustrated in FIG. 13 shows an architecture that may be adapted for a server computer, mobile phone, a PDA, a smartphone, a desktop computer, a netbook computer, a tablet computer, GPS device, gaming console, and/or a laptop computer. The architecture 1300 may be utilized to execute any aspect of the components presented herein.

The architecture 1300 illustrated in FIG. 13 includes a CPU 1302, a system memory 1304, including a RAM 1306 and a ROM 1308, and a system bus 1310 that couples the memory 1304 to the CPU 1302. A basic input/output system containing the basic routines that help to transfer information between elements within the architecture 1300, such as during startup, is stored in the ROM 1308. The architecture 1300 further includes a mass storage device 1312 for storing software code or other computer-executed code that is utilized to implement applications, the file system, and the operating system.

The mass storage device 1312 is connected to the CPU 1302 through a mass storage controller (not shown) connected to the bus 1310. The mass storage device 1312 and its associated computer-readable storage media provide non-volatile storage for the architecture 1300.

Although the description of computer-readable storage media contained herein refers to a mass storage device, such as a hard disk or CD-ROM drive, it should be appreciated by those skilled in the art that computer-readable storage media can be any available storage media that can be accessed by the architecture 1300.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1300.

According to various embodiments, the architecture 1300 may operate in a networked environment using logical connections to remote computers through a network. The architecture 1300 may connect to the network through a network interface unit 1316 connected to the bus 1310. It should be appreciated that the network interface unit 1316 also may be utilized to connect to other types of networks and remote computer systems. The architecture 1300 also may include an input/output controller 1318 for receiving and processing input from a number of other devices, including a keyboard, mouse, or electronic stylus (not shown in FIG. 13). Similarly, the input/output controller 1318 may provide output to a display screen, a printer, or other type of output device (also not shown in FIG. 13).

It should be appreciated that the software components described herein may, when loaded into the CPU 1302 and executed, transform the CPU 1302 and the overall architecture 1300 from a general-purpose computing system into a special-purpose computing system customized to facilitate the functionality presented herein. The CPU 1302 may be constructed from any number of transistors or other discrete circuit elements, which may individually or collectively assume any number of states. More specifically, the CPU 1302 may operate as a finite-state machine, in response to executable instructions contained within the software modules disclosed herein. These computer-executable instructions may transform the CPU 1302 by specifying how the CPU 1302 transitions between states, thereby transforming the transistors or other discrete hardware elements constituting the CPU 1302.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 1300 in order to store and execute the software components presented herein. It also should be appreciated that the architecture 1300 may include other types of computing devices, including handheld computers, embedded computer systems, smartphones, PDAs, and other types of computing devices known to those skilled in the art. It is also contemplated that the architecture 1300 may not include all of the components shown in FIG. 13, may include other components that are not explicitly shown in FIG. 13, or may utilize an architecture completely different from that shown in FIG. 13.

FIG. 14 is a functional block diagram of an illustrative mobile device 110 such as a mobile phone or smartphone including a variety of optional hardware and software components, shown generally at 1402. Any component 1402 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 1404, such as a cellular or satellite network.

The illustrated mobile device 110 can include a controller or processor 1410 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 1412 can control the allocation and usage of the components 1402, including power states, above-lock states, and below-lock states, and provides support for one or more application programs 1414. The application programs can include common mobile computing applications (e.g., image-capture applications, email applications, calendars, contact managers, web browsers, messaging applications), or any other computing application.

The illustrated mobile device 110 can include memory 1420. Memory 1420 can include non-removable memory 1422 and/or removable memory 1424. The non-removable memory 1422 can include RAM, ROM, Flash memory, a hard disk, or other well-known memory storage technologies. The removable memory 1424 can include Flash memory or a Subscriber Identity Module (SIM) card, which is well known in GSM (Global System for Mobile communications) systems, or other well-known memory storage technologies, such as “smart cards.” The memory 1420 can be used for storing data and/or code for running the operating system 1412 and the application programs 1414. Example data can include web pages, text, images, sound files, video data, or other data sets to be sent to and/or received from one or more network servers or other devices via one or more wired or wireless networks.

The memory 1420 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the mobile device 110.

The memory 1420 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The mobile device 110 can support one or more input devices 1430; such as a touch screen 1432; microphone 1434 for implementation of voice input for voice recognition, voice commands and the like; camera 1436; physical keyboard 1438; trackball 1440; and/or proximity sensor 1442; and one or more output devices 1450, such as a speaker 1452 and one or more displays 1454. Other input devices (not shown) using gesture recognition may also be utilized in some cases. Other possible output devices (not shown) can include piezoelectric or haptic output devices. Some devices can serve more than one input/output function. For example, touchscreen 1432 and display 1454 can be combined into a single input/output device.

A wireless modem 1460 can be coupled to an antenna (not shown) and can support two-way communications between the processor 1410 and external devices, as is well understood in the art. The modem 1460 is shown generically and can include a cellular modem for communicating with the mobile communication network 1404 and/or other radio-based modems (e.g., Bluetooth 1464 or Wi-Fi 1462). The wireless modem 1460 is typically configured for communication with one or more cellular networks, such as a GSM network for data and voice communications within a single cellular network, between cellular networks, or between the mobile device and a public switched telephone network (PSTN).

The mobile device can further include at least one input/output port 1480, a power supply 1482, a satellite navigation system receiver 1484, such as a GPS receiver, an accelerometer 1486, a gyroscope (not shown), and/or a physical connector 1490, which can be a USB port, IEEE 1394 (FireWire) port, and/or an RS-232 port. The illustrated components 1402 are not required or all-inclusive, as any components can be deleted and other components can be added.

Various exemplary embodiments of the present connection selection in hybrid networks are now presented by way of illustration and not as an exhaustive list of all embodiments. An example includes a computer-implemented method for selecting a preferred connection for calls carried at least in part over a hybrid communications network comprising loosely coupled network portions, the method comprising the steps of: collecting a plurality of inputs associated with past or current calls; generating a filtered list of available connections to the hybrid network, the filtering being implemented by using one or more of the collected inputs to eliminate connections from the list that do not meet selection criteria; sorting the filtered connection list by connection cost so that a least expensive connection is at the connection list's top; and using the connection at the top of the connection list as the preferred connection to the hybrid communications network.

In another example, the computer-implemented method further includes using the preferred connection when making an outbound call from a local device having telephony capabilities. In another example, the computer-implemented method further includes communicating the preferred connection to a remote service that is supported by the hybrid communications network so that the preferred connection is usable for routing of incoming calls to the local device. In another example, the computer-implemented method further includes receiving a notification of an incoming call from the hybrid communications network and indicating the preferred connection when accepting the incoming call. In another example, the inputs of the computer-implemented method include at least one of types of services desired for a call, cost of use for each available connection, whether a call is a special purpose call, user indicated connection preference, policies, availability of voice call continuity capability, historical call quality for each connection across a population of devices having telephony capabilities, historical call quality for each connection for a particular device having telephony capabilities, results of pre-call diagnostic testing, current and predicted characteristics of available connections, historical average time interval a mobile device having telephony capability was in range of each available connection, observed or inferred physical movement of a device having telephony capabilities, or location and predicted future location of a device having telephony capabilities. In another example, the computer-implemented method further includes persisting preferred connection status for a connection until the selection method is executed again. In another example, the computer-implemented method further includes sending the collected inputs to a remote network element in the hybrid communications network in which the remote network element uses the collected inputs to identify a preferred connection. In another example, the computer-implemented method further includes receiving a preferred connection from a network element in the hybrid communications network and using the received preferred connection to make outgoing calls. In another example, the computer-implemented method further includes reviewing a configuration of a preferred connection that is implemented as a virtual connection and using or skipping the preferred connection responsively to the review. In another example, the computer-implemented method further includes attempting connections over one or more network addresses when the preferred connection has multiple network addresses.

A further example includes a mobile device, comprising: one or more processors; and memory operatively coupled to the one or more processors and storing computer-readable instructions that, when executed by the one or more processors, perform a method for placing an outgoing call, the method comprising the steps of: establishing a connection to a hybrid communications network, the connection comprising either a Wi-Fi connection or cellular connection, the hybrid communications network comprising loosely coupled network portions, the network portions including at least a mobile operator network and a VoIP (Voice over Internet Protocol) network, comparing characteristics of available connections to the hybrid communications network against criteria describing one or more of call quality, call type, connection policies, or user preference to generate a list of connections ordered by cost; and using the least costly connection in the generated list to place the outgoing call.

In another example, the mobile device further includes employing call quality data that is crowd-sourced from a population of mobile devices. In another example, the mobile device further includes employing call quality data that is obtained from the mobile device. In another example, the mobile device further includes making predictions about potential movement of the mobile device and using the predictions when generating the connection list. In another example, the mobile device further includes taking into account availability of voice call continuity capabilities on the mobile device when generating the connection list. In another example, the mobile device further includes making predictions about potential for connection drop-outs within a predetermined time interval and using the predictions when generating the connection list. In another example, the mobile device further includes performing pre-call diagnostic tests on connection instances and using test results when generating the connection list.

A further example includes one or more computer-readable memories storing instructions for implementing a method for routing incoming calls to a mobile telephony device over a hybrid communications network, comprising: receiving data from inputs collected at the device, the device having a plurality of available connections to the hybrid communications network, the inputs describing connection selection criteria; using the received input data when running a connection selection methodology by comparing attributes for each connection instance to the connection selection criteria to generate a list of connections that is ordered according to connection cost; picking the least costly connection from the ordered list as the preferred connection; routing the incoming calls to the device using the preferred connection.

In another example, the one or more computer-readable memories further include communicating the preferred connection to the device. In another example, the one or more computer-readable memories obtain inputs describing connection selection criteria from one or more remote services.

Based on the foregoing, it should be appreciated that technologies for connection selection in hybrid networks have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A computer-implemented method for selecting a preferred connection for calls carried at least in part over a hybrid communications network comprising loosely coupled network portions, the method comprising the steps of:
collecting a plurality of inputs associated with past or current calls;
generating a filtered list of available connections to the hybrid network, the filtering being implemented by using one or more of the collected inputs to eliminate connections from the list that do not meet selection criteria;
sorting the filtered connection list by connection cost so that a least expensive connection is at the connection list's top; and
using the connection at the top of the connection list as the preferred connection to the hybrid communications network.

2. The computer-implemented method of claim 1 further including using the preferred connection when making an outbound call from a local device having telephony capabilities.

3. The computer-implemented method of claim 2 further including communicating the preferred connection to a remote service that is supported by the hybrid communications network so that the preferred connection is usable for routing of incoming calls to the local device.

4. The computer-implemented method of claim 1 further including receiving a notification of an incoming call from the hybrid communications network and indicating the preferred connection when accepting the incoming call.

5. The computer-implemented method of claim 4 in which the inputs include at least one of types of services desired for a call, cost of use for each available connection, whether a call is a special purpose call, user indicated connection preference, policies, availability of voice call continuity capability, historical call quality for each connection across a population of devices having telephony capabilities, historical call quality for each connection for a particular device having telephony capabilities, results of pre-call diagnostic testing, current and predicted characteristics of available connections, historical average time interval a mobile device having telephony capability was in range of each available connection, observed or inferred physical movement of a device having telephony capabilities, or location and predicted future location of a device having telephony capabilities.

6. The computer-implemented method of claim 1 further including persisting preferred connection status for a connection until the selection method is executed again.

7. The computer-implemented method of claim 1 further including sending the collected inputs to a remote network element in the hybrid communications network in which the remote network element uses the collected inputs to identify a preferred connection.

8. The computer-implemented method of claim 7 further including receiving a preferred connection from a network element in the hybrid communications network and using the received preferred connection to make outgoing calls.

9. The computer-implemented method of claim 1 further including reviewing a configuration of a preferred connection that is implemented as a virtual connection and using or skipping the preferred connection responsively to the review.

10. The computer-implemented method of claim 1 further including attempting connections over one or more network addresses when the preferred connection has multiple network addresses.

11. A mobile device, comprising:
one or more processors; and
memory operatively coupled to the one or more processors and storing computer-readable instructions that, when executed by the one or more processors, perform a method for placing an outgoing call, the method comprising the steps of:
establishing a connection to a hybrid communications network, the connection comprising either a Wi-Fi connection or cellular connection, the hybrid communications network comprising loosely coupled network portions, the network portions including at least a mobile operator network and a VoIP (Voice over Internet Protocol) network,
comparing characteristics of available connections to the hybrid communications network against criteria describing one or more of call quality, call type, connection policies, or user preference to generate a list of connections ordered by cost; and
using the least costly connection in the generated list to place the outgoing call.

12. The mobile device of claim 11 further including employing call quality data that is crowd-sourced from a population of mobile devices.

13. The mobile device of claim 11 further including employing call quality data that is obtained from the mobile device.

14. The mobile device of claim 11 further including making predictions about potential movement of the mobile device and using the predictions when generating the connection list.

15. The mobile device of claim 11 further including taking into account availability of voice call continuity capabilities on the mobile device when generating the connection list.

16. The mobile device of claim 11 further including making predictions about potential for connection drop-outs within a predetermined time interval and using the predictions when generating the connection list.

17. The mobile device of claim 11 further including performing pre-call diagnostic tests on connection instances and using test results when generating the connection list.

18. One or more computer-readable memories storing instructions for implementing a method for routing incoming calls to a mobile telephony device over a hybrid communications network, comprising:
receiving data from inputs collected at the device, the device having a plurality of available connections to the hybrid communications network, the inputs describing connection selection criteria;
using the received input data when running a connection selection methodology by comparing attributes for each connection instance to the connection selection criteria to generate a list of connections that is ordered according to connection cost;
picking the least costly connection from the ordered list as the preferred connection;
routing the incoming calls to the device using the preferred connection.

19. The one or more computer-readable memories of claim 18 further including communicating the preferred connection to the device.

20. The method of claim 18 further including obtaining inputs describing connection selection criteria from one or more remote services.
